(19) United States
(12) Patent Application Publication
(10) Pub. No.: US 2009/0099011 A1
(43) Pub. Date: Apr. 16, 2009

(54) Catalyst for Emission Gas Purification

(76) Inventor: Masahide Miura, Shizuoka (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/922,456

(22) PCT Filed: Jun. 20, 2006
(86) PCT No.: PCT/JP2006/312675

§ 371 Date: Dec. 19, 2007

(30) Foreign Application Priority Data
Jun. 20, 2005 (JP) 2005-179884

(51) Int. Cl. B01J 23/10

(52) U.S. Cl. 502/303; 502/304

(57) ABSTRACT

A catalyst 10 for purifying emission gas including a substrate 12, and on the substrate 12, a first catalyst layer 14 including a cerium oxide-zirconia based composite support supporting Pt or Pd, a second catalyst layer 16 including a support containing zirconia as a main component that supports Rh, and a diffusion barrier layer 18 interposed between the first catalyst layer 14 and the second catalyst layer 16 and containing metal oxide whose electronegativity is lower than that of Ce.

### TECHNICAL FIELD

The present invention relates to a catalyst for emission gas purification that eliminates carbon monoxide, hydrocarbon and nitrogen oxide in emission gas emitted from internal combustion engines.

### BACKGROUND ART

As catalysts for automobile emission gas purification, 3-way catalysts for purifying emission gas have conventionally been employed by oxidizing carbon monoxide (CO) and hydrocarbon (HC) and reducing nitrogen oxide (NOₓ) at the same time. For example, 3-way catalysts have been known widely that comprise a heat resistant substrate made of cordierite and a coat layer that is made of γ-alumina and formed on the substrate. Noble metal catalysts such as platinum (Pt), palladium (Pd) and rhodium (Rh) are supported on the coat layer.

On the other hand, a problem of inactivation of automotive catalysts under an exposure of the catalysts to emission gas at a high temperature (about 1000° C.) is a solid solution produced by movements of atoms such as Pt or Rh that is activation points. For this reason, catalysts have been proposed in which a support is provided for each type of a metal and constituted by 2-way coating.

Japanese Utility Model Application Publication (JP-Y) No. 4-51864 discloses, as a catalyst for emission gas purification using Pt, Pd and Rh, a catalyst for emission gas treatment comprising a honeycomb substrate, and two (upper and lower) layers or more supported on the honeycomb substrate, one layer supporting cerium (Ce) and platinum (Pt) and the other layer supporting Rh and Zr.

Further, Japanese Patent Application (JP-A) No. 9-925 discloses an NOₓ catalyst for emission gas purification in which a support of alumina particle is coated with Pt/alumina, cerium oxide (or BaO, La₂O₃), Rh/alumina and Co/alumina in this order from the inside and which exhibits excellent NOₓ purification performance.

Moreover, JP-A No. 2003-117393 discloses a catalyst that contains a particle supporting Rh and a particle consisting of an alumina support that supports Pt and is coated with cerium oxide(-zirconia composite oxide).

### DISCLOSURE OF THE INVENTION

However, like the catalysts listed in the above-description, even in the case of a catalyst in which a Pt or Rh containing layer is separated into two layers or more, when a Pt containing layer and an Rh containing layer are arranged close to each other, due to a movement of Pt or the like between the layers at the time of a high temperature, a solid solution of Pt and Rh is produced.

Further, like the NOₓ catalyst for emission gas purification, even in the case of a catalyst having a Pt containing layer, an Rh containing layer, and a cerium oxide or the like containing layer interposed between the Pt containing layer and the Rh containing layer, movements of Pt and Rh between the layers cannot be fully prevented. Accordingly, a problem is caused in that it is difficult to maintain initial properties for a long period of time.

In order to solve the aforementioned facts, an object of the present invention is to provide a catalyst for emission gas purification in which a movement of a catalyst metal between layers at the time of a high temperature can be prevented, and initial characteristics can be maintained for a long period of time.

A first aspect of the present invention is to provide a catalyst for emission gas purification containing a substrate; and on the substrate, at least a first catalyst layer including a cerium oxide-zirconia based composite support supporting Pt or Pd; a second catalyst layer including a support containing zirconia as a main component that supports Rh; and a diffusion barrier layer interposed between the first catalyst layer and the second catalyst layer and including metal oxide whose electronegativity is lower than that of Ce.

In the catalyst for emission gas purification of the present invention, the diffusion barrier layer containing the metal oxide, whose electronegativity is lower than that of Ce, is interposed between the first catalyst layer containing Pt or Pd and the second catalyst containing Rh. Therefore the catalyst for emission gas purification of the present invention is able to trap moving Pt and Pd atoms by the diffusion barrier layer. Further, the catalyst for emission gas purification of the present invention can prevent movements of Pt and Pd atoms between the first layer and the second layer without degrading activity of the catalyst even at the time of a high temperature.

This is supposed to be because the cerium oxide-zirconia based composite support as a support for the first catalyst layer, the support containing zirconia as a main component as the second catalyst layer, and the diffusion barrier layer containing metal oxide, whose electronegativity is lower than that of Ce, are used in combination prevent Pt atom and the like from moving.

Here, the “substrate having zirconia as a main component” refers to a substrate containing zirconia in an amount of 60% by mass or more.

The “metal oxide whose electronegativity is lower than that of Ce” refers to metal oxide having electronegativity which is relatively lower than that of Ce. For example, if Ce has electronegativity of about 1.0 to 1.2, suitable metal oxides should have electronegativity whose values are lower than those of Ce. Further, the diffusion barrier layer in the present invention does not contain metal atoms (however, except metal atoms produced by the movement between the layers).

In the catalyst for emission gas purification of the present invention, it is preferable that the diffusion barrier layer contains at least one of cerium oxide and lanthanum oxide.

Further, thickness of the diffusion barrier layer is preferably 20 μm to 50 μm. Further, a cross section of the catalyst for emission gas purification of the present invention is observed by using an SEM (scanning electron microscope) or the like to measure thickness of each layer.

### BRIEF DESCRIPTION OF DRAWINGS

FIG. 1A is a schematic cross-sectional view for illustrating a structure of a catalyst for emission gas purification of the present invention; and

FIG. 1B is a schematic cross-sectional view for illustrating the structure of the catalyst for emission gas purification of the present invention.

### BEST MODE FOR CARRYING OUT THE INVENTION

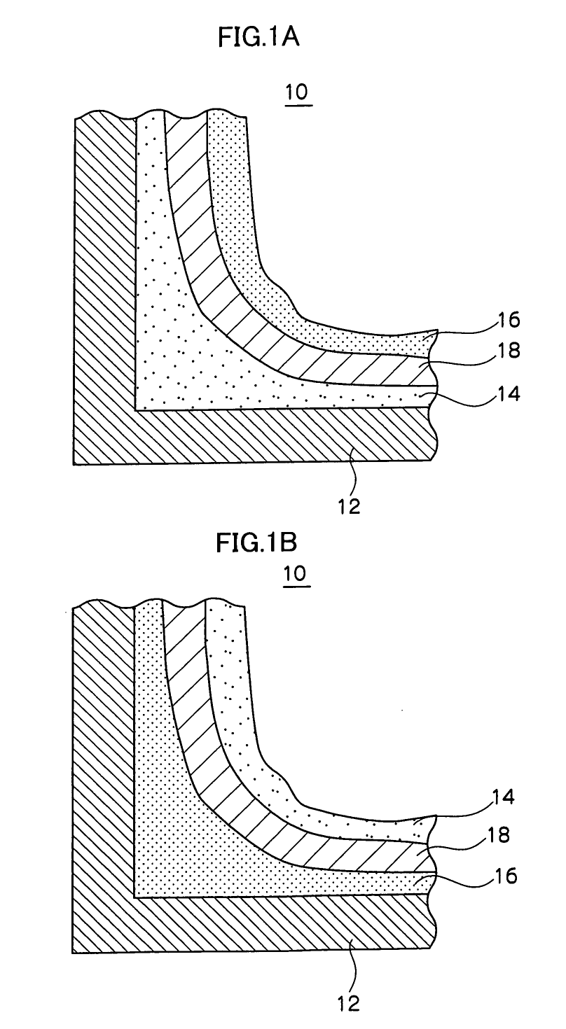

Hereinafter, with reference to drawings, a description of a catalyst for emission gas purification of the present invention will be made. FIGS. 1A and 1B are schematic cross-sectional views for illustrating a structure of the catalyst for emission gas purification of the present invention. As shown in FIG. 1A, a catalyst 10 for emission gas purification of the present invention includes a substrate 12, and on the substrate 12, at least a first catalyst layer 14 in which Pt (platinum) or Pd (palladium) is supported on a cerium oxide-zirconia based composite support, a second catalyst layer 16 in which Rh (rhodium) is supported on a support containing zirconia as a main component, and a diffusion barrier layer 18 which is interposed between the first catalyst layer 14 and the second catalyst layer 16 and which contains metal oxide whose electronegativity is lower than that of Ce (cerium).

The catalyst 10 for emission gas purification of the present invention may have a structure of stacking the first catalyst layer 14, the diffusion barrier layer 18, and the second catalyst layer 16 on the substrate 12 in this order, as shown in FIG. 1A or of stacking the second catalyst layer 16, the diffusion barrier layer 18, and the first catalyst layer 14 on the substrate 12 in this order, as shown in FIG. 1B.

The first catalyst layer 14 is a layer containing cerium oxide-zirconia based composite support supporting Pt or Pd. Specifically, the cerium oxide-zirconia based composite support can use a solid solution of cerium oxide and zirconia, wherein the solid solution contains cerium oxide in an amount of 50% by mass or more, and preferably contains at least one additive or more selected from the group consisting of alkaline earth metals and rare earth metals. Further, the shape of the cerium oxide-zirconia based composite support is not limited. For example it can use a particle of the cerium oxide-zirconia based composite support.

From a standpoint of an activity contribution ratio, the amount of Pt or Pd which is supported on the cerium oxide-zirconia based composite support is preferably 0.1 to 10% by mass with respect to the cerium oxide-zirconia based composite support, and more preferably 0.1 to 5% by mass with respect to the cerium oxide-zirconia based composite support. Further, a noble metal catalyst used in the catalyst for emission gas purification of the present invention is preferably Pt. The noble metal catalyst used in the catalyst for emission gas purification of the present invention may use Pt and Pd in combination. From standpoints of gas diffusion properties and thermal capacity, the content of the cerium oxide-zirconia based composite support (containing a mass amount of a catalyst metal supported thereon) in the first catalyst layer 14 is preferably 30 to 90% by mass, and more preferably 60 to 90% by mass.

The first catalyst layer 14 can use not only the cerium oxide-zirconia based composite support and Pt or Pd but also a binder as necessary. Sols can be used for the binders. Use of sols, which do not have influences on main components in support particle for forming catalyst layers or on catalyst metals (i.e., without covering Pt with heating) and which do not interfere catalyst reactions, is preferable. Also, viscosity of the sols can be controlled beforehand by using an oxide or an alkali. Examples of sols to be used in the present invention include ZrO₂ sols and CeO₂ sols as well as Al₂O₃ sols. From standpoints of gas diffusion properties and thermal capacity, the content of the binder in the first catalyst layer 14 is preferably 10 to 70% by mass, and more preferably 10 to 40% by mass.

Thickness of the first catalyst layer 14 is not particularly limited; however, it is ordinarily 10 μm to 200 μm, and preferably 40 μm to 100 μm.

The second catalyst layer 16 is a layer including a support containing zirconia as a main component that supports Rh. As described above, the “support containing zirconia as a main component” refers to a support containing zirconia in an amount of 60% by mass or more. The content of zirconia in the support containing zirconia as a main component is preferably 70% by mass or more, and more preferably 80% by mass or more. Specifically, as a support containing zirconia as a main component, use of a zirconia support including a composite of zirconia and at least one rare earth element is enabled, and a zirconia support including a composite of zirconia and lanthanum is preferable. Further, the shape of the support containing zirconia as a main component is not limited. For example it can use a particle of the support containing zirconia as a main component.

From a standpoint of an active contribution ratio, the amount of Rh supported on the support containing zirconia as a main component is preferably 0.1 to 10% by mass with respect to the support containing zirconia as a main component, and more preferably 0.1 to 5% by mass with respect to the support containing zirconia as a main component. Further, from standpoints of gas diffusion properties and thermal capacity, the content of the support containing zirconia as a main component (containing a mass amount of Rh supported thereon) in the second catalyst layer 16 is preferably 30 to 90% by mass, and more preferably 60 to 90% by mass.

The second catalyst layer 16 can use not only the support containing zirconia as a main component and Rh but also a binder as necessary. A sol can be used for the binder. The second catalyst layer 16 can use the same sol as that in the first catalyst layer 14. From standpoints of gas diffusion properties and thermal capacity, the content of the binder in the second catalyst layer 16 is preferably 10 to 70% by mass, and more preferably 10 to 40% by mass.

Thickness of the second catalyst layer 16 is not particularly limited, and is generally within a range of 10 μm to 200 μm, and preferably within a range of 10 μm to 60 μm.

The diffusion barrier layer 18 is a layer which is disposed between the first catalyst layer 14 and the second catalyst layer 16, and which contains metal oxide whose electronegativity is lower than that of Ce. Movement of a noble metal between layers can be prevented by the diffusion barrier layer 18. Examples of metal oxide which is contained in the diffusion barrier layer 18 and whose electronegativity is lower than that of Ce include cerium oxide (CeO₂) and lanthanum oxide (La₂O₃), calcium oxide (CaO), strontium oxide (SrO), barium oxide (BaO) and the like, and from a standpoint of heat resistance, use of cerium oxide and lanthanum oxide is preferable. Electronegativity of the metal oxide is preferably about 0.79 to 1.0, and more preferably 0.9 to 1.0, when the electronegativity of Ce is 1.0. Electronegativity of the metal oxide can indicate isoelectric points of oxides, for example.

The diffusion barrier layer 18 can include not only metal oxide whose electronegativity is lower than that of Ce but also a binder as necessary. The binder can use such sols as described above. However, from a standpoint of sufficiently preventing a movement of a catalyst metal between layers, use of ZrO₂ sol and CeO₂ sol is preferable. From standpoints of gas diffusion properties and thermal capacity, the content of the binder in the diffusion barrier layer 18 is preferably 10 to 70% by mass, and more preferably 10 to 40% by mass.

From a viewpoint of enhancing activity of the catalyst 10 for emission gas purification of the present invention (from a viewpoint of catalyst performances), thickness of the diffusion barrier layer 18 is preferably 20 μm to 50 μm. The thickness of the diffusion barrier layer 18 can be adjusted by controlling a total solid matter concentration during the preparation of slurry for the diffusion barrier layer. Further, no metals other than the trapped catalyst noble metals are included in the diffusion barrier layer 18.

Examples of the substrate include ceramic and metal. Further, the substrate is not limited to a particular structure; however, it can use a honeycomb structure, for example.

The catalyst 10 for emission gas purification of the present invention can be prepared by a known method in which the first catalyst layer 14, the second catalyst layer 16, and the diffusion barrier layer 18 are stacked on the substrate such that the diffusion barrier layer 18 is interposed between the first catalyst layer 14 and the second catalyst layer 16.

Specifically, first, a substrate is dipped into slurry which is prepared by mixing a cerium oxide-zirconia based composite support (powder) supporting Pt, sol such as zirconia sol and an appropriate amount of ion exchange water. Thereafter, the substrate is dried at an electric furnace or the like after wiping off an excessive amount of the slurry, and then the substrate is subjected to a burning. Accordingly, the first catalyst layer can be formed on the substrate. At this point, the temperature of burning the substrate is preferably 400 to 800° C., and more preferably 500 to 700° C.

Next, the substrate on which the first catalyst layer is formed is dipped into slurry that is prepared by mixing cerium oxide (ceria), ceria sol and an appropriate amount of ion exchange water. Thereafter, the substrate is dried at an electric furnace or the like after wiping off an excessive amount of the slurry, and then the substrate is subjected to a burning. Accordingly, the diffusion barrier layer can be formed on the first catalyst layer. At this point, the temperature of burning the substrate is preferably 400 to 800° C., and more preferably 500 to 700° C.

Further, the substrate having the first catalyst and the diffusion barrier layer formed thereon is dipped into slurry which is prepared by mixing a support containing zirconia as a main component that supports Rh (for example, a solid solution of zirconia and yttria), zirconia sol, and an appropriate amount of ion exchange water. Thereafter, the substrate is dried at an electric furnace or the like after wiping off an excessive amount of the slurry, and then the substrate is subjected to a burning. Accordingly, the second catalyst layer can be formed on the diffusion barrier layer. At this point, the temperature of burning the substrate is preferably 400 to 800° C., and more preferably 500 to 700° C.

As described above, the present invention can provide a catalyst for emission gas purification in which a movement of a catalyst metal between layers at the time of a high temperature can be prevented, and initial characteristics of the catalyst can be maintained for along period of time. The catalyst for emission gas purification of the present invention can be used widely for apparatuses for emitting emission gas from internal combustion engines of automobiles.

### EXAMPLES

With reference to Examples, a detailed description of the catalyst for emission gas purification of the present invention will be made. However, the present invention is not limited to these.

### Example 1

### Preparation of the Catalyst for Emission Gas Purification

### 1. Formation of the First Catalyst Layer

10 parts by mass (the conversion of solid matters) of zirconia sol (manufactured by Daiichi Rare Element Chemical Industry Co., Ltd.) and an appropriate amount (about 5 parts by mass) of ion exchange water were added to 100 parts by mass of 1% by mass of Pt/CZY powder (a solid solution supporting Pt and consisting of CeO₂, ZrO₂ and Y₂O₃, and is manufactured by Cataler Corporation) which were milled by a ball mill for 100 hours and mixed for one hour by the ball mill to prepare slurry.

Then, ceramic honeycomb TP (35 cc) (substrate; manufactured by NGK INSULATORS, LTD.) was naturally dipped into the obtained slurry. Thereafter, slurry in excess was blown away from the substrate, and then the substrate was dried at 120° C. for eight hours by an electric furnace. Then, the dried substrate was burned at 500° C. for three hours, and a substrate (1) on which the first catalyst layer supporting Pt was formed was obtained. Further, the coating amount of the first catalyst layer was adjusted so as to have Pt in an amount of 1.5 (g/l).

### 2. Formation of the Diffusion Barrier Layer

10 parts by mass (the conversion of solid matters) of cerium oxide sol (manufactured by Taki Chemical Co., Ltd.) and an appropriate amount (about 5 parts by mass) of ion exchange water were added to a high surface cerium oxide (metal oxide whose electronegativity is lower than that of Ce; manufactured by Anan Kasei Co., Ltd.) which was milled for 100 hours by using the ball mill, and mixed for an hour by using the ball mill to prepare slurry.

Next, the substrate (1) was naturally dipped into the obtained slurry. Thereafter, slurry in excess was blown away from the substrate (1), and then the substrate (1) was dried at 120° C. for eight hours by an electric furnace. Then, the dried substrate (1) was burned at 500° C. for three hours, and a substrate (2) in which a diffusion barrier layer containing cerium oxide was formed on the first catalyst layer containing Pt was obtained. Further, the thickness of the diffusion barrier layer was 48 μm.

### 3. Formation of the Second Catalyst Layer

10 parts by mass (the conversion of solid matters) of zirconia sol (manufactured by DAIICHI KIGENSO KAGAKU KOGYO CO., LTD.) and an appropriate amount (about 5 parts by mass) of ion exchange water were added to 100 parts by mass of 0.5% by mass-Rh/ZY (a zirconia-yttria solid solution supporting Rh; manufactured by DAIICHI KIGENSO KAGAKU KOGYO CO., LTD.) to prepare slurry.

Next, the substrate (2) was naturally dipped into the obtained slurry. Thereafter, slurry in excess was blown away from the substrate (2), and the then substrate (2) was dried at 120° C. for eight hours by an electric furnace. Then, the dried substrate (2) was burned at 500° C. for three hours, and the catalyst for emission gas purification of the present invention in which the second catalyst layer containing Rh is formed on the diffusion barrier layer was obtained. Moreover, the coating amount of the second catalyst layer was adjusted so as to contain Rh in an amount of 0.3 (g/1).

### Examples 2 to 5

In “2. Formation of the diffusion barrier layer” in Example 1, catalysts for emission gas purification in Examples 2 to 5 were prepared in the same manner as in Example 1 except that concentrations of total solid matters contained in the slurries were adjusted thus allowing the diffusion barrier layers to have thicknesses as shown in Table 1 below. Further, thickness of each diffusion barrier layer was observed by using SEM.

### Comparative Example 1

A catalyst for emission gas purification in Comparative Example 1 was prepared in the same manner as that in Example 1 except that the second catalyst layer was directly disposed on the first catalyst layer without interposing the diffusion barrier layer therebetween.

TABLE 1

| | | Diffusion | |
|---|---|---|---|
| | | Barrier Layer | |
| | | Compo- | Thick- |
| | Layer Structure | sition | ness(μm) |
| Example 1 | 1st catalyst layer/diffusion barrier | CeO₂ | 48 |
| | layer/2nd catalyst layer | | |
| Example 2 | 1st catalyst layer/diffusion barrier | CeO₂ | 33 |
| | layer/2nd catalyst layer | | |
| Example 3 | 1st catalyst layer/diffusion barrier | CeO₂ | 21 |
| | layer/2nd catalyst layer | | |
| Example 4 | 1st catalyst layer/diffusion barrier | CeO₂ | 53 |
| | layer/2nd catalyst layer | | |
| Example 5 | 1st catalyst layer/diffusion barrier | CeO₂ | 16 |
| | layer/2nd catalyst layer | | |
| Comparative | 1st catalyst layer/2nd catalyst layer | None | — |
| Example 1 | | | |

### Evaluation

### 1. Durability Test

Durability test was conducted such that the catalyst for emission gas purification was sealed, and rich atmospheric gas and lean atmosphere gas that simulate automobile emission gas and have compositions shown in Table 2 were repeated every one minutes, and this was continued at 1050° C. for eight hours. Thereafter, a diffused state of structural elements in the second catalyst layer was observed by an X-ray microanalyzer (EPMA), and the movement of Pt between layers was evaluated in accordance with the following criteria. The results are shown in Table 3 below.

Criteria

A: no movement of Pt between layers was observed.
B: some movements of Pt between layers were observed, but were within an allowable range.
C: noticeable movements of Pt between layers were observed.

### 2. Evaluation Test of Purification Performance

Evaluation test was carried out such that the catalyst for emission gas purification was sealed, and rich atmospheric gas and lean atmosphere gas that simulate automobile emission gas and that have compositions shown in Table 2 as below were repeated at 1 Hz during increasing the temperature, and a temperature (HC-T50) at which HC(C₃H₆) is purified by 50% was measured. The results are shown in Table 3.

TABLE 2

| | N₂ | CO₂ | NO | CO | C₃H₆ | H₂ | O₂ | H₂O |
|---|---|---|---|---|---|---|---|---|
| | (%) | (%) | (ppm) | (%) | (ppm) | (%) | (%) | (%) |
| Rich | balance | 10 | 2200 | 2.80 | 2500 | 0.27 | 0.77 | 10 |
| atmo- | | | | | | | | |
| spheric | | | | | | | | |
| gas | | | | | | | | |
| Lean | balance | 10 | 2200 | 0.81 | 2500 | 0 | 1.7 | 10 |
| atmo- | | | | | | | | |
| sphere | | | | | | | | |
| gas | | | | | | | | |

TABLE 3

| | | Evaluation test of |
|---|---|---|
| | Durability test (degree | purification |
| | of movement of Pt | performance |
| | between layers) | (HC-T50) |
| Example 1 | A | 323° C. |
| Example 2 | A | 310° C. |
| Example 3 | A | 317° C. |
| Example 4 | A | 372° C. |
| Example 5 | B | 346° C. |
| Comparative | C | 350° C. |
| Example 1 | | |

In Examples 1 to 4, the movement of Pt between layers after the durability test was not observed in the second catalyst layer. Further, in Example 5, although a certain amount of movement of Pt between layers was observed, it was within an allowable range. On the other hand, in Comparative Example 1, the movement of Pt between layers was confirmed noticeably. Further, in Examples 1 to 3 in which thickness of the diffusion barrier layer is within a range of 20 μm to 50 μm, the temperature (HC-T50) at which HC(C₃H₆) is purified by 50% is more excellent than in Comparative Example 1.

As described above, the present invention can provide a catalyst for emission gas purification which is capable of preventing a catalyst metal from moving between layers at the time of a high temperature and maintaining initial characteristics for a long period of time.

The disclosure of Japanese Patent Application No. 2005-179884 is incorporated herein by reference in its entirety.

1. A catalyst for emission gas purification comprising:
a substrate; and on the substrate, at least
a first catalyst layer including a cerium oxide-zirconia based composite support supporting Pt or Pd;
a second catalyst layer including a support containing zirconia in an amount of 60% by mass or more, the support supporting Rh; and
a diffusion barrier layer interposed between the first catalyst layer and the second catalyst layer, the diffusion barrier layer including CeO₂ La₂O₃, CaO, SrO, or BaO.

2. The catalyst for emission gas purification according to claim 1, wherein the diffusion barrier layer comprises at least one selected from the group consisting of cerium oxide and lanthanum oxide.

3. The catalyst for emission gas purification according to claim 1, wherein the thickness of the diffusion barrier layer is within a range of 20 μm to 50 μm.

4. The catalyst for emission gas purification according to claim 1, wherein the cerium oxide-zirconia based composite support in the first catalyst layer is a solid solution of cerium oxide and zirconia, wherein the solid solution contains cerium oxide in an amount of 50% by mass or more.

5. The catalyst for emission gas purification according to claim 1, wherein the amount of Pt or Pd supported on the cerium oxide-zirconia based composite support in the first catalyst layer is 0.1 to 10% by mass with respect to the cerium oxide-zirconia based composite support.

6. The catalyst for emission gas purification according to claim 1, wherein the thickness of the first catalyst layer is 10 μm to 200 μm.

7. The catalyst for emission gas purification according to claim 1, wherein the support containing zirconia as a main component in the second catalyst layer is a zirconia support comprising a composite of zirconia and at least one rare earth element.

8. The catalyst for emission gas purification according to claim 1, wherein the amount of Rh supported on the support containing zirconia as a main component in the second catalyst layer is 0.1 to 10% by mass with respect to the support containing zirconia as a main component.

9. The catalyst for emission gas purification according to claim 1, wherein the thickness of the second catalyst layer is 10 μm to 200 μm.
